(19) United States
(12) Patent Application Publication
(10) Pub. No.: US 2008/0243725 A1
(43) Pub. Date: Oct. 2, 2008

(54) Systems And Methods For Tracking State-Based Transactions

(75) Inventors: William Homan-Muise, Seal Beach, CA (US); John Dicamillo, Rancho Santa Margarita, CA (US); Bob Richardson, Huntington Beach, CA (US); Mark Dicamillo, Dove Canyon, CA (US); Joseph R. Simrell, Coto de Caza, CA (US)

Correspondence Address: LATHROP & GAGE LC, 4845 PEARL EAST CIRCLE, SUITE 300, BOULDER, CO, 80301, US

(73) Assignee: Primal Solutions Inc.

(21) Appl. No.: 12/055,933

(22) Filed: Mar. 26, 2008

Related U.S. Application Data
(60) Provisional application No. 60/909,339, filed on Mar. 30, 2007.

(51) Int. Cl. G06Q 30/00; G06Q 10/00; G06F 15/173; G06F 17/30

(52) U.S. Cl. 705/400; 709/224; 707/103 R; 707/E17.046

(57) ABSTRACT

Systems and methods track state-based transactions. Event tokens from devices of one or more networks are collected, formatted, normalized and stored in association with state-based transactions. Each of the transaction instances, and the associated event tokens, is processed using transaction definitions and zero, one or more actions are performed in association with the transaction instance. Missing event may be determined for each incomplete transaction based upon the transaction definitions. Problems across multiple networks may be diagnosed by determining quality of service for each of the transactions. Transactions between peering networks may be settled by monetizing the state-based transactions and generating billing information based upon the monetized state-based transactions. Abnormal behavior within an enterprise network is identified by evaluating the event tokens to identify state-based transactions of abnormal behavior.

### RELATED APPLICATIONS

This application claims priority to U.S. Provisional Application Ser. No. 60/909,339, filed Mar. 30, 2007, and incorporated herein by reference.

### BACKGROUND

Internet Protocol (IP), convergence, competition and fundamental changes in network technologies are driving massive changes in the structure and economics of communications and the delivery of new media. As communications and content providers restructure and reorganize to align their operations to support new services offerings and business models, they are also establishing new third party relationships in order to more competitively deliver new IP services. As the IP services and business relationships required to deliver them become more complex, so too does the IP transactions and IP data produced thereby.

To prevent lost revenues and to properly manage their costs, advanced communications providers, new media companies and even enterprises need to come to terms with increasingly complex IP services. From seemingly simple Voice-over IP (VoIP) services to network peering, interactive multimedia and IPTV, these IP services are becoming increasingly complex together with their delivery method and the data that they create.

Today, as trillions of IP packets propagate across provider and partner networks, most service providers are unable to accurately track, aggregate, “slice and dice” or interpret IP transactions. As a result, they are unable to capture full value from the services they offer or enable, and operational experience and analysis has demonstrated that, even without knowing it, these providers may be losing hundreds of thousands of dollars of revenue every month.

For example, assume a services provider has 600,000 consumers using its VoIP service. On average, these consumers make one directory assistance (DA) and 0.09 operator-assisted (OA) calls each month (i.e., 9 calls per 100 subscribers). The service provider uses third parties to process these DA and OA calls at a price if $1.00 wholesale and $1.50 retail. The provider thus gets $981,000 in revenues, pays $654,000 in third party charges and therefore realizes $327,000 in profit. However, according to Aberdeen Consulting as reported in the Washington Post, Sep. 6, 2004: “Telecommunications firms are good targets for bill-watching . . . Local, long-distance and wireless carriers pay to use each others' networks, and the rates they pay are always changing, which is why so many mistakes occur. Seven to 12 percent of bills end up in error.” If for example, we assume that transaction errors average five percent as they have in standard telecommunication company billing environments, this service provider could experience as much as $49,050 in lost revenue and $16,350 in lost profit each month. This scenario does not take into consideration the wide array of other services that VoIP subscribers use that may also put revenues at risk and increase provider costs.

In order to compete with standard voice services, VoIP providers must process international calls, calls that originate or terminate on other networks, calls using 10-10 service calls, collect and credit card transactions and a host of other possible transactions. As service providers add complementary offerings such as second line service, messaging, multimedia or video phone to their basic package, the potential for dropped transactions, lost revenues and unmanaged costs escalate.

In the commercial services space, the problem and economics of lost transactions may be even more profound. First, commercial services are typically more expensive; therefore, the potential for lost revenue due to lost or improperly managed transactions is even greater. Next, because commercial customers are less tolerant of service and accounting problems than consumers, lost transactions could very quickly translate into lost business.

International Data Corporation (IDC) has identified the “monetization” of content as a key business driver in the evolving service delivery world. IDC predicts that XML will play a more central role in information management platforms, as will web services and service oriented architectures.

Many services are now being delivered over multiple networks, such as the Internet and private computer networks, using an Internet Protocol (IP). For example, a Voice over Internet protocol (VoIP) telephone service allows telephone calls to be transacted over one or more networks. However, accounting for such calls becomes difficult since the call may result in an IP transaction having many event tokens that are generated by different devices within the networks. Some of these event tokens are generated as the events occur within each network, whereas other event tokens may not be generated until some time after the event. For example, certain event tokens may not be generated until several days after the VoIP call has completed. Thus, managing and determining costs for each IP transaction on the network is extremely difficult.

Systems and networks are becoming more complex; the number and types of services offered by these systems and networks are growing and involve more parties. Consumers and governments are requesting greater flexibility and accountability of the services delivered. In addition, the use of these services has been growing exponentially and is expected to continue to grow rapidly.

Traditionally, event tokens are fed to a reporting data warehouse from the mediation system. Aside from all the issues that normally surround enterprise data warehouse initiatives (project duration, agility, timeliness, etc.) there are several more complex and subtle problems with this approach. Foremost, this approach is based upon batched/scheduled processing; real-time or near real-time processing is not an option. This approach also requires a larger hardware investment to scale the environment for the processing spikes of each batch while leaving large amounts of idle or low load time. Changes to the data warehouse to support changing business models are usually slow and simplified to support the broadest possible constituent base and are often dependent upon the ability to fit the new processing requirements into existing windows of opportunity.

Analytic reports generated from the data warehouse typically use relationships and constraints as part of their data queries, but these relationships are not explicitly preserved for detailed forensics. Missing data, where a data element required for a transaction has not been captured, is very difficult to identify by the data warehouse, since these values are not selected by dependent database joins and are therefore very difficult to identify.

### SUMMARY

In an embodiment, a method tracks a state-based transaction. Transaction definitions that define each type of state-based transaction and its associated business rules ate generated. A plurality of event tokens from devices of one or more networks are collected, formatted and normalized. For event tokens that are not associated with a stored IP transaction, the event tokens are grouped into groups of like event token type. An IP transaction instance is generated for each type of IP transaction in the IP transaction definitions that is associated with the event token type and each of the generated IP transaction instances is stored within a transaction archive. For each of the generated IP transaction instances, each of the grouped event tokens is stored in association with the stored IP transaction. For event tokens that are associated with a stored IP transaction instance, each of the event tokens is stored in association with their associated IP transaction instances. Each of the IP transaction instances, and the associated event tokens, is processed using the IP transaction definitions and zero, one or more actions are performed in association with the IP transaction instance.

In an embodiment, a system tracks state-based transactions from disparate sources. A collector/formatter collects and formats event tokens from the sources. If the event tokens are not associated with at least one existing event-based transaction, a transaction broker groups the formatted event tokens into groups of like event token types and creates one state-based transaction containing each of the event tokens for each possible transaction type associated with the event token type of each group. A transaction data access component stores each of the state-based transactions and associated event tokens into a transaction archive. A plurality of action components take actions, based upon one or more transaction definitions, in association with one or more of the state-based transactions. At least one of the actions determines a transaction state for one or more of the state-based transactions; the transition state indicates whether the state-based transaction is complete.

In an embodiment, a method stores state-based transaction information. Event tokens for one or more state-based transactions are received. If the event tokens are not associated with an existing transaction, the event tokens are grouped based upon an event token type, a state-based transaction is generated for each transaction type within a transaction definition document and in association with each of the event tokens of the group, and the state-based transactions and their associated event tokens are stored in a transaction archive. If the event tokens are associated with an existing state-based transaction, the event token are stored within the transaction archive in association with the existing state-based transaction.

In an embodiment, a method determines missing events. Transaction definitions specifying one or more states and state transitions for each of the one or more state-based transactions are defined for one or more state-based transactions. One or more event tokens are received. If the event tokens are not associated with a state-based transaction within a transaction archive, the event tokens are grouped according to event token type. A state-based transaction is generated for each transaction type of state-based transactions defined within the transaction definitions and each of the event tokens of the group is associated with each of the generated state-based transactions. The state-based transactions and their associated event tokens are stored in a transaction archive. If the event tokens are associated with an existing state-based transaction, the event token is stored within the transaction archive in association with the existing state-based transaction. For each incomplete state based transaction within the transaction archive, missing events are determined based upon the transaction definitions.

In an embodiment, a method diagnoses problems across multiple networks. State-based transactions are tracked by receiving, processing and storing event tokens from the multiple networks. Quality of service is determined for each of the state-based transactions and state-based transactions with problems are identified based upon the determined quality of service. Event tokens of the state-based transaction are evaluated to identify one or more devices within the multiple networks.

In an embodiment, a system settles transactions between peering networks, including means for tracking state-based transactions across the peering networks, means for monetizing the state-based transactions, and means for generating billing information based upon the monetized state-based transactions.

In an embodiment, a method identifies abnormal behavior within an enterprise network. Event tokens of state-based transactions within the network are collected for a defined period during which normal activity occurs on the network. Normal behavior of the network is determined based upon the collected event tokens. Transaction definitions for the determined normal behavior are generated and include business rules that identify abnormal behavior on the network. Event tokens of state-based transactions within the network are collected after the defined period and the event tokens are evaluated to identify state-based transactions of abnormal behavior. If abnormal behavior is identified, at least one alert is generated for the abnormal behavior.

### BRIEF DESCRIPTION OF THE FIGURES

FIG. 1 shows an exemplary Internet Protocol (IP) transaction resulting from a call between a telephone connected to a first network and a telephone connected to a public switched telephone network.

FIG. 2 shows one exemplary system embodiment for tracking IP transactions in a network having a plurality of service providers.

FIG. 3 shows one exemplary system embodiment for tracking IP transactions across a plurality of networks for a plurality of service providers.

FIG. 4 is a graph illustrating exemplary multiple and concurrent use of a network by a user.

FIG. 5 shows the IP transaction engine of FIGS. 2 and 3 in further detail, according to one embodiment.

FIG. 6 shows one exemplary system embodiment for tracking RFID transactions.

FIG. 7 shows one exemplary system embodiment for tracking healthcare transactions.

FIG. 8 shows one exemplary XML broker request message.

FIG. 9 shows one exemplary system embodiment for tracking IP transactions within an enterprise network to identify abnormal behavior.

FIG. 10 is a flowchart illustrating one exemplary method for tracking state-based transactions of one embodiment.

### DETAILED DESCRIPTION OF THE FIGURES

An IP transaction defines the behavior exhibited in response to a set of related network events that form a complete IP network service action. A voice over internet protocol (VoIP) subscriber accepting and participating in a collect telephone call initiated on a public switched telephone network (PSTN) is one example of an IP transaction. IP transactions typically embody or wrap network events from a variety of sources into a comprehensive, end-to-end business activity record.

A set of business rules defines the tokens, actions, and states for a particular class or type of IP transaction. The IP transaction and its event tokens, states and sub-transactions are structured to allow the IP transaction to be stored for later interpretation and analysis. This structure also allows a variety of event token types and document payload types to be stored. IP transactions may be represented equally well, for example, by XML documents and relational database tables. An IP transaction may exist in one of many defined states as various event tokens, itemized in its definition, are collected. Thus, the IP transaction is always in a known state and constrained by its definition.

Within an IP transaction engine, an IP Transaction has a set of related network events, the actions taken in response to those events, and the history of transaction states produced by those actions. A network event is represented by a standardized format event token that includes the salient attributes of the network event, such as an event type, a timestamp, an originating device and duration. IP transactions may be merged or nested within one another to model complex chains of real-world network events. Since event tokens and data elements that form an IP transaction are not necessarily available at the same time, the IP transaction, unlike an Atomic, Consistent, Isolation and Durable (ACID) transaction, may be evaluated many times before it is judged to succeed or fail. The IP transaction has a finite number of event tokens, a finite number of actions, a history of state transitions, and boundary conditions based upon time and/or state.

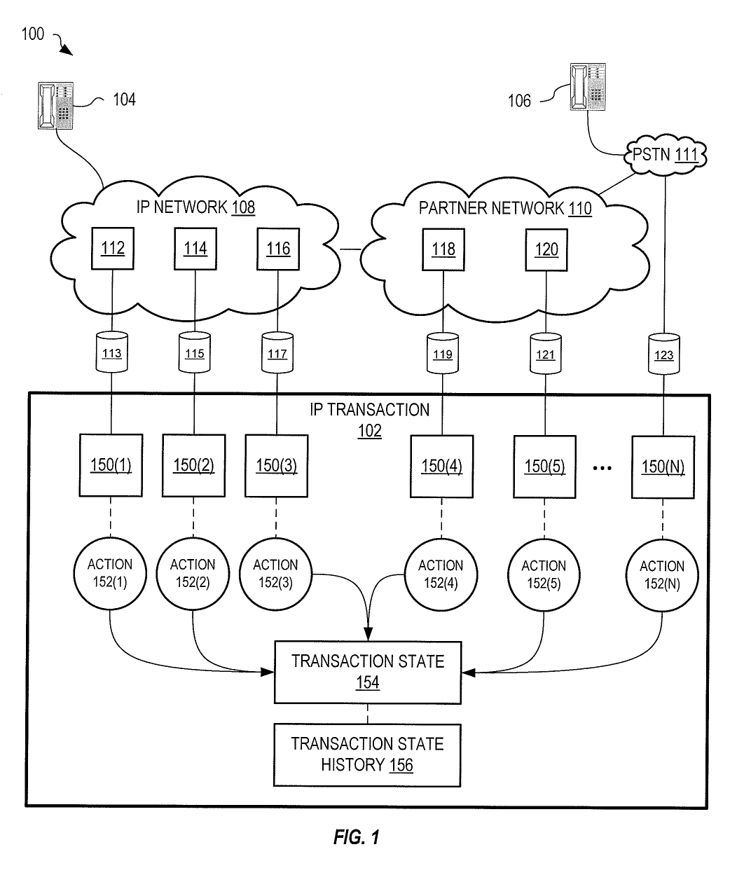

FIG. 1 shows one exemplary IP transaction 102 that occurs when a VoIP call is made between a first telephone apparatus 104, connected to an IP network 108, and a second telephone apparatus 106, connected to a Public Switched Telephone Network (PSTN) 111. The call utilizes devices 112. 114 and 116 of IP network 108, devices 118 and 120 of partner network 110 and connects to PSTN 111. Devices 112, 114, 116, 118 and 120 may be one or more of a RADIUS server, a policy server, a gateway, a soft switch, a mediation service, a billing system, and all other elements that are involved in processing the service or transaction. Devices 112, 114, 116, 118 and 120 and PSTN 111 generate data streams 113, 115, 117, 119, 121 and 123, respectively, that include IP event tokens 150(1)-150(N). Event tokens 150 may be generated synchronously and in relatively short periods (e.g., seconds), and may be generated asynchronously and separated by extend periods (e.g., days or weeks). For example, where PSTN 111 operates upon a monthly billing cycle, certain event tokens (e.g., event token 150(N)) generated by PSTN 111 may not be available for several days after the VoIP call terminates, whereas event tokens 150(2) and 150(3) may be generated immediately upon call setup. Further, since event tokens 150 are generated by disparate devices, they typically are not delivered to a central processing facility.

Event tokens (e.g., event tokens 150) represent discrete messages collected from a network (e.g., networks 108, 110 and PSTN 111) and may be collected from network elements (e.g., devices 112, 114, 116, 118, 120) as continuous streams (e.g., data streams 113, 115, 117, 119, 121, 123) or as files. These event tokens may result from discrete events, in the form of a single token with a single message, or from steaming events that are not differentiated by delivery mechanism but by markers and protocols observed within the stream. An event token may contain one or more sets of attributes that are considered common to all network events, such as: a unique ID, a token type (e.g., AMA/BAF, BTS CDR and SAMIS record), a service type (e.g., long distance call and movie download), a time of event, a time of collection, an event duration, a source (e.g., network element ID, originating device and location, terminating device and location, account ID), and charges.

Since IP transaction 102 is formed of a plurality of event tokens 150 that are generated as the service is performed, IP transaction 102 may exist in one of a finite number of states that is reached depending on the success or failure of each action associated with IP transaction 102.

Transaction 102 is shown with actions 152 associated with each event token 150. Actions 152 represents program functions that are applied to IP transaction 102 (and may also be applied to other IP transactions) in order to move IP transaction 102 toward a definite conclusion. That is, actions 152 may modify a transaction state 154 that represents a current status of IP transaction 102, wherein upon transaction state 154 reaching one or more specific states, IP transaction 102 becomes complete.

Actions may be used to: enforce business rules, transform event tokens, create new event tokens, calculate values, aggregate and correlate event tokens, persist any data within the scope of the transaction, and generate and persist meta-data about the transaction including, status conditions, error states, check points, log data and notification messages. Actions may be designed to execute synchronously or asynchronously. In one embodiment, actions are implemented by service components in a JBI container. Individual actions may be embedded logic in Java, or implemented using an embedded scripting language such as JavaScript. Some action components may delegate most or all of their processing to one or more database stored procedures through an IP Transaction Broker. All action components are responsible for updating the state of all processed transactions to indicate either success or failure.

Since transaction state 154 has a finite number of possible states, IP transaction 102 is always in a well-defined state. Each action 152 invocation updates transaction state to indicate the success or failure of the action.

IP transaction 102 also includes a transaction state history 156 that is a history of transaction state 154 state transitions and may include one or more of: a timestamp of state transition, a result state, a prior state, an action name, a process ID (optional), and a user ID (optional). IP Transaction 102 has one of three final states: complete, failed and expired. That is, IP transaction 102 boundaries are based upon either state or time. Certain states of transaction state 154 are identified as the successful or unsuccessful completion of IP transaction 102. IP transaction 102 may be defined to complete within a specified period; if it does not complete within this period it has failed and is marked as expired (e.g., using a special expired transaction state).

Instances of IP transactions (e.g., IP transaction 102) are persisted in a transaction archive and may include attributes such as: unique ID, transaction type, incept date, lifespan, current state, state transition history, event token(s), and nested or merged IP transactions.

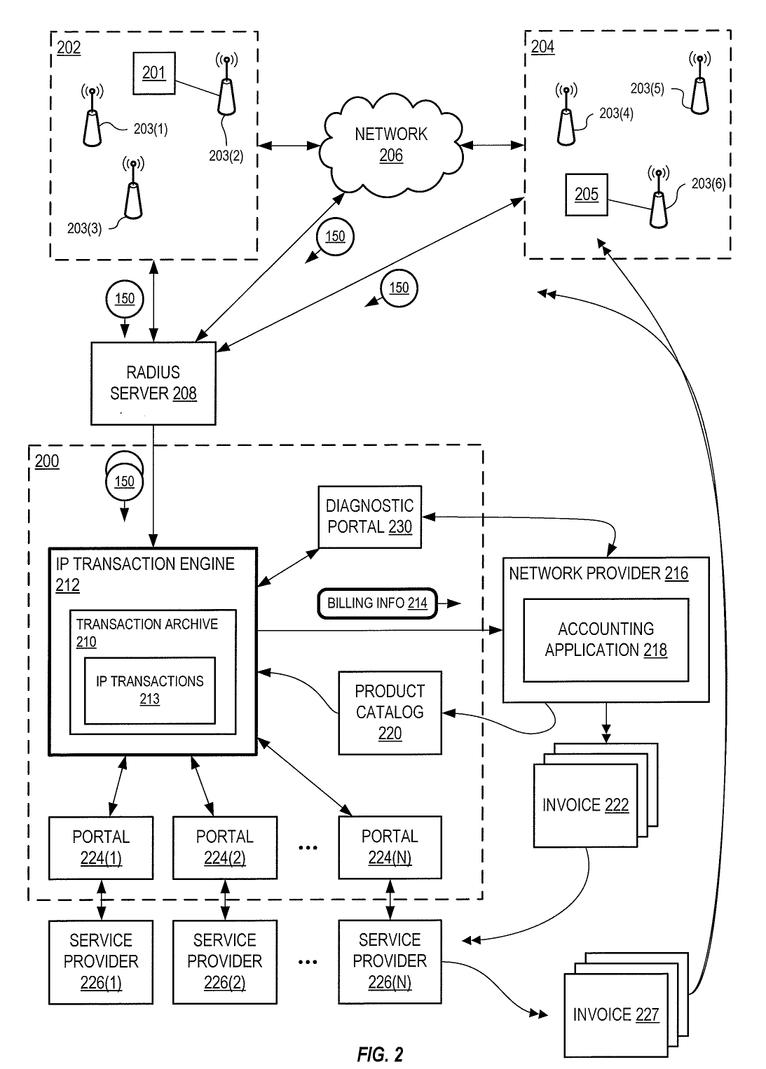

FIG. 2 shows one exemplary system 200 for tracking IP transactions for a plurality of Service Providers 226. A first area 202 and a second area 204 contain access points 203 that are interconnected by a network 206 that is operated by a network provider 216. Services of network 206 are marketed within areas 202 and 204 by a plurality of service providers 226(1)-226(N). A radius server 208 provides access control, authentication and accounting for network 206 and access points 203.

In one operational example, a user 201 within area 202 connects to access point 203(2) and places a VoIP call to a user 205 connected to access point 203(6) within area 204. Radius server 208 authenticates users 201 and 205 and allows them access to network 206. Radius server 208 also receives IP transaction information, shown as event tokens 150, from network 206 as services of network 206 are used by users 201 and 205. Event tokens 150 are then sent from radius server 208 to a transaction archive 210 of system 200 where they are stored and processed by an IP transaction engine 212. IP transaction engine 212 tracks each IP transaction within network 206 based upon received event tokens 150.

Network provider 216 creates a product catalog 220 to specify usage constraints and billing parameters for service providers 226. In one embodiment, product catalog 220 specifies costs and service agreement information for each service provider 226 based upon determined usage of network 206 by users 201 and 205. Product catalog 220 allows IP transaction engine 212 to generate billing information 214 based upon determined usage of network 206 resources and services by users 201 and 205. Billing information 214 is sent to network provider 216. In one example, an accounting application 218 of network provider 216 receives billing information 214 and generates invoices 222 that are sent to service providers 226.

Billing information 214 is based upon completed IP transactions 213 that are indicative of network 206 use by users of network 206 (i.e., subscribers of service providers 226). Since IP transactions 213 correlates event tokens 150 by user (e.g., users 201, 205), service provider 226, usage type, etc., IP transaction engine 212 determines IP transactions 213 in association with service providers 226. Accounting application 218 may then generate invoices 222 for each service provider 226 based upon determined use of network 206. Billing information 214 may include appropriate fees and taxes applicable to each service provider 226. In turn, service providers 226 may then generate and send one or more invoices 227 to users 201, 205.

System 200 also has portals 224 that allow service providers 226 to evaluate and settle disputes arising over any one or more IP transaction. In one embodiment, portals 224 provide web based access to certain information within transaction archive 210; thereby, service providers 226 access portals 224 using web browsers.

In one operational example, user 201 sends a complaint to service provider 226(2) regarding poor service. Service provider 226(2) investigates any one or more IP transactions made by user 201 to determine whether, or not, to dispute an invoice 222 from network provider 216. In another operational example, service provider 226(1) utilizes portal 224(1) to view IP transactions that are completed with a failed transaction state. Since IP transaction engine 212 processes IP transactions in near real-time, service provider 226(1) may identify and resolve disputable IP transaction issues prior to receiving the associated invoice from network provider 216. That is, portals 224 allow service providers 226 to resolve IP transaction disputes without involving network provider 216.

In the example of FIG. 2, portal 224(1) is configured to allow service provider 226(1) to view only IP transactions associated with service provider 226(1) and its customers; portal 224(2) is configured to allow service provider 226(2) to view only IP transactions associated with service provider 226(2) and its customers; and portal 224(N) is configured to allow service provider 226(N) to view only IP transactions associated with service provider 226(N) and its customers. That is, one service provider cannot view information of another service provider through portal 224.

System 200 may also include a diagnostic portal 230 that allows network provider 216 to identify and investigate problems with network 206. In one operational example, network provider 216 uses diagnostic portal 230 to identify IP transactions that failed and/or expired and to evaluate event tokens of these IP transactions to identify one or more specific parts and/or devices (e.g., devices 112, 114, 116, 118, 110 of FIG. 1) of network 206 that may require maintenance and/or replacement. Network provider 216 may also utilize diagnostic portal 230 to further investigate IP transaction disputes by service providers 226.

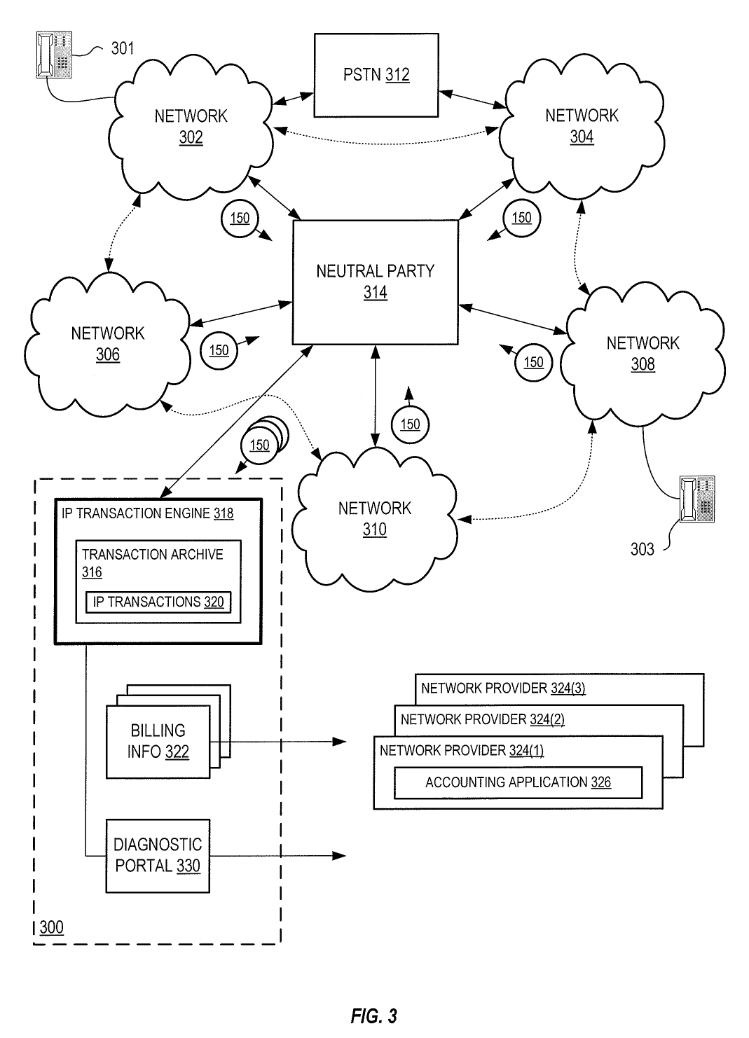

FIG. 3 shows one exemplary system 300 for tracking IP transactions 320 across a plurality of networks 302, 304, 306, 308, 310 for a plurality of service providers 324. System 300 has five interconnected networks 302, 304, 306, 308 and 310 and a neutral party 314 that connects to each network. Neutral party 314 receives event tokens 150 from each network 302, 304, 306, 308 and 310 and passes these tokens 150 to a transaction archive 316 for storage and processing. Neutral party 314 may provide other functionality to system 300, such as SIP based routing information and thereby forms a convenient point in the network topology for collecting event tokens and forwarding them to system 300. Neutral party 314 may also processes SIP routing requests, report on Quality of Service (QoS) and record duration of network utilization.

IP transaction engine 318 has a transaction archive 316 and processes received event tokens 150 to identify and track IP transactions 320. Certain devices (e.g., switches, SIP servers, session boarder controllers, exchange message interface devices, policy management servers, etc.) within networks 302, 304, 306, 308 and 310 send certain event tokens 150 to neutral party 314 which forwards them to IP transaction engine 318 for processing into IP transactions 320 by system 300; other event tokens 150 may be sent to neutral party 314 later (e.g., certain event tokens 150 may be sent to neutral party 314 several days after the IP transaction event has completed). IP transaction engine 318 uses a product catalog (e.g., product catalog 220, FIG. 2) to determine and generate billing information 322 that is sent to one or more network providers 324. Specifically, each network provider 324 receives billing information 322 that is applicable to use of their network and their use of other networks. Where traffic is routed dynamically over networks 302-310, the detailed accounting provided by billing information 322 prevents many transaction disputes between network providers 324.

Using the example of FIG. 3, a VoIP call between two parties, 301 and 303, may form as a peered connection. Since system 300 receives event tokens 150 from multiple networks, it is able to identify the VoIP call as an IP transaction and therefore determine the cost of the call for each of the utilized networks based upon the IP transaction.

Prior to the use of system 300, networks 302-310 may have had to operate as a partnership (i.e., sharing resources based upon an ‘estimated’ usage). The use of system 300 resolves resource sharing and provides accurate resource usage. Thus, through use of system 300, partner agreements may be based upon actual data rather than estimates.

Transaction Diagnostics over Multiple Networks

More particularly, system 300 is ideally positioned to monitor and diagnose components and devices of each network by monitoring quality of IP transactions. In one example of operation, transaction archive 316 receives event tokens 150 for IP transactions occurring within networks 302-310. By monitoring certain statistical information within each IP transaction, and particularly for IP transactions that fail and/or expire, IP transaction engine 318 may identify problems within any one or more of networks 302-310. In fact, even where each network has a monitoring operator, inter-network problems are often not identifiable from within the network. IP transaction engine 318 processes IP transactions 320 that occur across many networks and provides a diagnostic portal 330 that allows network providers 324 to view detailed statistics of IP transactions 320 that utilize multiple networks, thereby facilitating identification of problems that occur across multiple networks. In one embodiment, system 300 performs such monitoring automatically, alerting appropriate personnel when statistics indicate a problem (and/or potential problem) within one or more networks. In one example, system 300 generates one or more of: email, text messages and pages for such personnel.

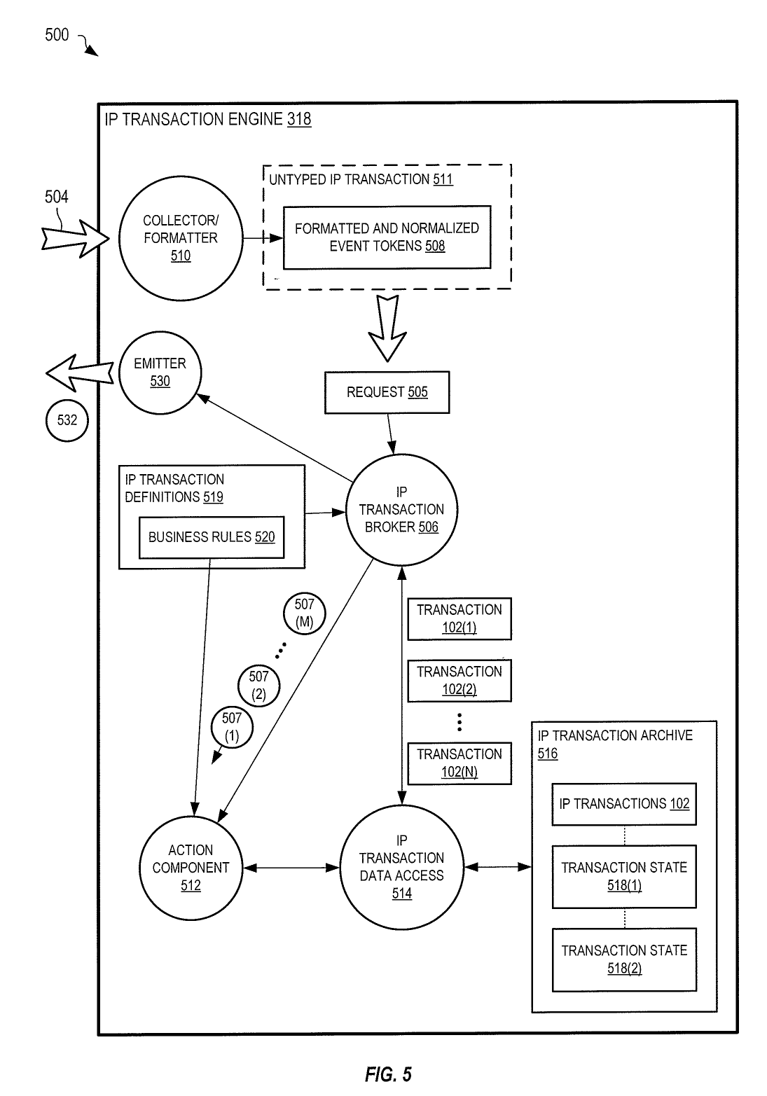

The central service of system 300 is IP Transaction Engine 318. IP transaction engine 318 includes infrastructure for defining and managing IP transactions (e.g., IP transactions 320, IP transaction 102, FIG. 1), as well as providing configuration and messaging between a plurality of action components that process these transactions. IP transaction engine 318 is shown in further detail in FIG. 5. IP transaction engine 318 is formed of a set of Java Business Integration (JBI) Service Engines (SE), Action components (AC) and Binding Components (BC) that communicate over an Enterprise Service Bus architecture. IP transaction engine 318 is described in further detail below and shown in FIG. 5.

### Identifying and Costing Multiple Concurrent Network Usage

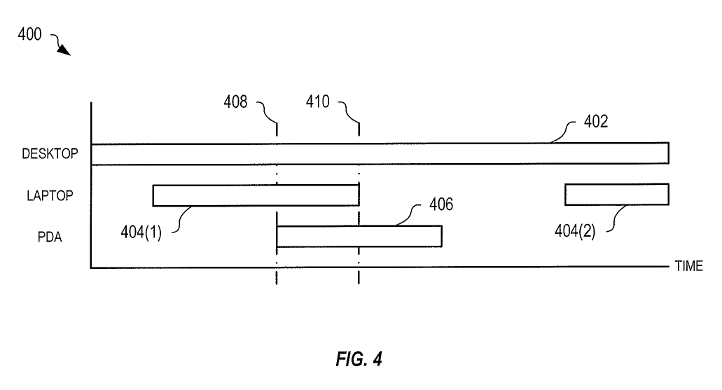

FIG. 4 is a graph 400 illustrating exemplary multiple and concurrent use of a network by a user. Graph 400 shows a first use 402 of the network by the user's desktop computer that is shown continuously connected to a network. A laptop computer is shown connected to the network by bars 404(1) and 404(2). That is, the user utilizes the laptop computer periodically. Bar 406 shows the user's PDA connecting to the network. As shown in FIG. 4, between a first time 408 and a second time 410, the user has three simultaneous connections to the network. Thus, all IP transactions that occur between the first time 408 and the second time 410 may be billed at a higher rate based upon the user's service plan as specified by the service provider. Even if the user connects through different networks (e.g., when roaming etc.) the IP transaction system still resolves all IP transactions to that user.

In particular, systems 200 and 300 may detect simultaneous use of network resources by each user. Where a service provider charges a user based upon time connected and the number of simultaneous connections, systems 200 and 300 may automatically detect such activity and thereby automatically invoke the appropriate billing amount. For example, where a service provider has a first rate for a first connection, a second rate for a second connection and a third rate for a third or more simultaneous connections, systems 200 and 300 may determine and provide appropriate billing to the network provider, and thus to the service providers.

Often a service provider implements measures to detect and prevent simultaneous connection to a network. For example, a municipal WiFi provider may desire to limit the number of simultaneous connections using the same login (i.e., the same account) to one or two in order to prevent miss-use (e.g., where a user provides their friends with their account information). Typically this requires additional software within the RADIUS server (and/or at other locations within the network) to trace each login, to detect multiple logins in to deny access.

However, it may be more advantageous to create service plans that implement a changing billing rate based upon the number of simultaneous logins, or the amount of simultaneous time usage, or the bandwidth consumed, or combinations thereof, for each user account. For example, the service plan may define a first rate for a first and second simultaneous connection and a second rate for additional simultaneous connections, where the second rate is higher than the first rate. Thus it is not advantageous to ‘share’ a single login between friends, since simultaneous access increases fees payable.

FIG. 5 shows IP Transaction Engine 318, FIG. 3, with an IP Transaction Broker SE 506, an IP Transaction Data Access SE 514, various Collector/Formatter BCs 510 and Various Action Component SEs 512. These components communicate with one another by sending IP Transactions as normalized XML messages. In one embodiment, IP Transaction Engine 318 uses content-based routing (i.e., routing based upon the content of the normalized messages) to direct event tokens 508 to the appropriate components (e.g., action components 512) based upon rules defined in an IP Transaction Definition document 519 (see Code Sample 1—Exemplary IP Transaction Definition Document).

### Code Sample 1—Exemplary IP Transaction Definition Document

```
<?xml version=“1.0” encoding=“UTF-8”?>
<ipc:transactionDefinition xmlns:ipc=“http://primal.com/ipc”
xmlns:xsi=“http://www.w3.org/2001/XMLSchema-instance”
  elementFormDefault=“qualified” xsi:schemaLocation=“http://
ipc.primal.com/ipc ipc.xsd”>
  <ipc:transactionType name=“Master_Invoice” />
  <ipc:transactionLife Custs=“days” life=“90” />
  <ipc:tokens>
    <ipc:token type=“Cycle_End”
          table=“CY_CYCLE_END”
          sequence=“CY_SEQ_CYCLE_END”>
```

| | |
|---|---|
| <ipc:field name=“Cust_ID” | type=“Long” /> |
| <ipc:field name=“Billing_Period_ID” | type=“Long” /> |
| <ipc:field name=“Start_Date” | type=“Date” /> |
| <ipc:field name=“End_Date” | type=“Date” /> |

```
      <ipc:tokens>
        <ipc:token ref=“Invoice_Line_Item”/>
      </ipc:tokens>
    </ipc:token>
    <ipc:token type=“Invoice_Line_Item”
            table=“CY_LINE_ITEM”
            sequence=“CY_SEQ_LINE_ITEM”
            mutable=“true”>
```

| | |
|---|---|
| <ipc:field name=“Cust_ID” | type=“Long” /> |
| <ipc:field name=“Cust_Billing_Period_ID” | type=“Long” /> |
| <ipc:field name=“Product_ID” | type=“Long” /> |
| <ipc:field name=“Location_Code” | type=“String” /> |
| <ipc:field name=“Acct_Number” | type=“String” /> |
| <ipc:field name=“Item_Code” | type=“String” /> |
| <ipc:field name=“Item_Description” | type=“String” /> |
| <ipc:field name=“Quantity” | type=“Decimal” /> |
| <ipc:field name=“Cust_Price” | type=“Decimal” /> |
| <ipc:field name=“Extended_Price” | type=“Decimal” /> |
| <ipc:field name=“Supporting_Detail” | type=“String” /> |

```
    </ipc:token>
  </ipc:tokens>
  <ipc:actions>
    <ipc:actionDefinition name=“Correlator”>
      <ipc:state name=“correlated” />
    </ipc:actionDefinition>
    <ipc:actionDefinition name=“Rater” select=“correlated”>
      <ipc:state name=“rated” />
    </ipc:actionDefinition>
    <ipc:actionDefinition name=“Exporter” select=“rated”>
      <ipc:state name=“complete” />
    </ipc:actionDefinition>
  </ipc:actions>
  <ipc:transactions>
    <ipc:transaction ref=“Billing_Cycle”>
      <ipc:correlation>
      <ipc:oneToOne/>
      </ipc:correlation>
    </ipc:transaction>
    <ipc:transaction ref=“Billable_Event”>
      <ipc:correlation>
      <ipc:rule language=“JavaScript”>
<![CDATA[
  function isValidDateRange(master, event) {
    return master.Cycle_End.Start_Date <= event.Event.Timestamp
      && master.Cycle_End.End_Date  >= event.Event.Timestamp;
  }
  function IPC_correlationTest(master, event) {
    return master.Cycle_End.Cust_ID == event.Event.Cust_ID
      && isValidDateRange(master, event);
  }
]]>
      </ipc:rule>
      </ipc:correlation>
    </ipc:transaction>
  </ipc:transactions>
</ipc:transactionDefinition>
```

### Transaction Broker

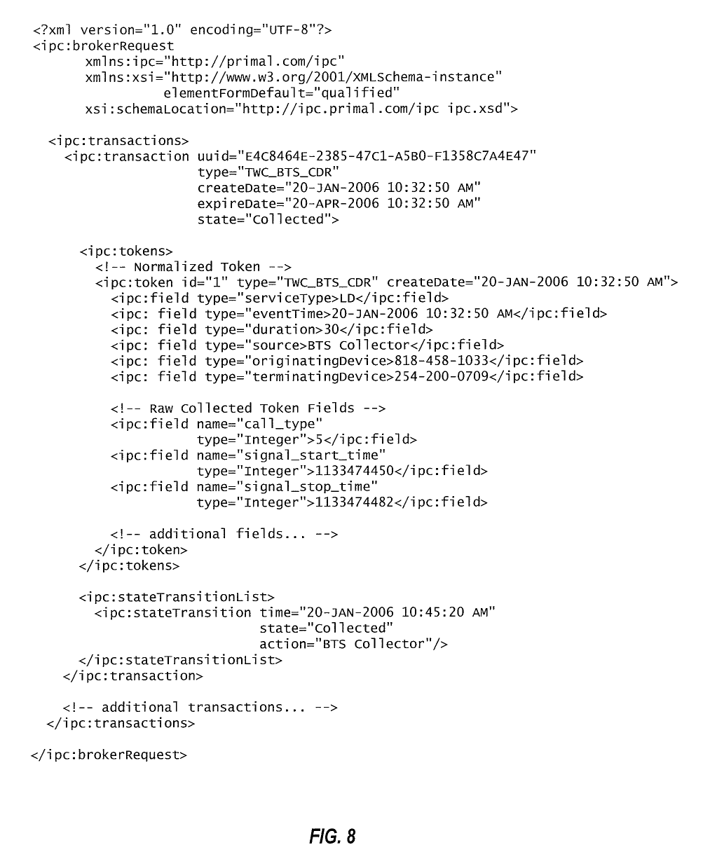

Transaction broker 506 is responsible for implementing the rules described in IP transaction definition document 519. IP Transactions and their associated event tokens and state transition history are sent to transaction broker 506 in the form of normalized messages on the ESB formatted as a request 505. Transaction broker 506 receives each request 505 in the form of a message (e.g., XML) that may contain a set of one or more IP Transactions (or pseudo transaction elements 511), along with their associated event tokens, and state transition records, or may contain an IP Transaction query that is evaluated to produce a set of IP Transactions. Request 505 may contain a set of transactions to be processed, or may contain a query that will return a set of transactions to be processed from the IP transaction archive 516. FIG. 8 shows one exemplary XML broker request message. In one embodiment, each request 505 is assigned to a separate worker thread for processing.

### Collected Event Processing

When event tokens are initially collected from an external source 504 (e.g., raw data streams from one or more network devices), they are not bound to any specific IP Transaction. Collector/formatter components 510 parses external source 504, extracts native event tokens into formatted and normalized event tokens 508 (e.g., XML messages) using the same schema as all other messages processed by IP transaction engine 318. Collector/formatter 510 may wrap related event tokens and state transitions in a untyped IP transaction 511, in which the following data attributes are not specified: a UUID, a type, a create date, and an expire date. The untyped IP transaction wrapper allows the tokens(s) to be processed by IP transaction broker 506 even though a permanent IP transaction designation has not yet been assigned.

Request 505 contains one or more untyped IP transactions 511. Each untyped IP transaction 511 contains one or more event tokens 508 that may be declared to be mutable or immutable. Event tokens collected from external sources are generally considered to be immutable for auditing purposes. Event tokens generated by IP transaction engine 318 to hold computed values may be mutable and altered one or more times by action component 512. Mutations of event tokens and state transitions may also be logged or wrapped in their own transaction (e.g., IP transaction 102) and persisted in IP transaction archive 516 to support auditing and other functions.

### IP Transaction Processing

Where request 505 contains a set of IP transactions, IP transaction broker 506 first submits the entire set of IP transactions to an IP transaction data access module 514 that stores the current state of each IP transaction, mutable event token and any unsaved immutable event tokens in appropriate tables in IP transaction archive 516. State transitions and immutable event tokens are inserted into archive 516 when they are initially created; once persisted they are never updated.

IP transaction broker 506 does not route IP transactions that have not been stored in IP transaction archive 516; thus a worker thread created to process request 505 is blocked until IP transaction data access module 508 has completed persisting the transaction records of request 505.

When IP transaction broker 506 receives request 505 containing one or more pseudo-transaction elements 511, each untyped IP transaction 511 containing one or more formatted and normalized event tokens 508, IP transaction broker 506 organizes the pseudo-transaction elements 511 into groups based upon normalized event token type. The normalized event token type, which is assigned by collector/formatter 510, is for example an attribute within each formatted and normalized event token. For each such group, IP transaction broker 506 identifies all transaction definitions within IP transaction definition document 519 that reference the normalized event token type (i.e., it finds all possible transaction types that the grouped event tokens 508 could belong to), and creates a new transaction for each transaction type found, shown as transactions 102(1)-102(N). IP transaction broker 506 then sends each group to IP data access module 514 to archive 516.

Where broker request 505 contains a transaction query, IP transaction broker 506 first evaluates this query against IP transaction archive 516 and produces a set of IP transactions that satisfy the conditions of the query. This resulting set of IP transactions 102 is processed as described above.

### IP Transaction Routing

Once the transactions have been persisted, IP transaction broker 506 separates the transactions into groups according to their transaction type. If any of these IP transactions do not have a valid transaction type, they are identified within a warning-level alert raised by IP transaction broker 506. IP transaction broker 506 then evaluates the action selectors within IP transaction definition document 519 for each remaining type of transaction. Any IP transaction that is in an unrecognized state according to its corresponding transaction definition within IP transaction definition document 519 is identified within a warning-level alert raised by IP transaction broker 506.

All other transactions are formatted into request messages (shown as messages 507(1)-507(M)) and assigned to an appropriate action component 512 based upon one or more action selectors specified within IP transaction definition document 519 in association with the transaction type. Thus, IP transaction broker 506 may create many request messages 507 for each request 505.

### Transaction Data Storage

As described with respect to FIG. 5, IP transactions 102 are stored within IP transaction archive 516. Since event tokens (e.g., formatted and normalized event tokens 508) are not necessarily received in order, event tokens are stored within IP transaction archive 516 in association with one or more IP transactions 102 and may be processed by IP transaction broker 506 many times before IP transaction 102 is deemed to have completed. The explicit linking of event tokens to IP transactions and IP transaction states allows event tokens missing from an incomplete transaction to be identified, allows errors in the order of processing (if an order is required) to be identified and allows significant interim states of incomplete transactions to be identified. More specifically, this explicit linking allows for easy and unambiguous identification of what went wrong in one or more failed IP transactions.

### Transaction Data Use

IP transaction archive 516, which includes all received event tokens for each transaction, provides data for other uses, such as to identify problems within a network or within multiple networks. Each user of systems 200, 300 may define an IP transaction type that reflects their specific needs and values. For example, a finance user may define an IP transaction type that identifies whether an inter-partner settlement has been properly executed. In another example, a customer service user defines an IP transaction type that determines a quality of service value. In another example, a marketing user may define an IP transaction type the allows evaluation of the usage of a particular product or customer group.

IP transaction engine 318 may include an emitter 530, which is a special class of action component, that may output normalized messages 532. Messages 532 may take the form of a file to be written to disk or a message to be sent to another network device or system. This allows the IP transaction engine 318 to behave as a message proxy between systems and allows billing information to be output to billing systems (e.g., output of billing information 322 to accounting application 326 of FIG. 3). External systems may thereby integrate with IP transaction engine 318 through a combination of sending messages through a collector (e.g., collector/formatter 510) and receiving a response from emitter 530.

### Settlement

Since each IP transaction 102 is in a defined state at all times and each event token for that transaction is recorded within IP transaction archive 516, IP transaction engine 318 facilitates monetary settlement of each complete IP transaction for multiple partners. For example, as shown in FIG. 3, IP transactions 320 are tracked for multiple network providers 324 and billing information 322 is provided to each network provider 324 based upon their use of other network provider resources and other network provider usage of their resources. IP transaction definitions 519 include business rules 520 that define financial (charge rates and taxation rules) for each part of each IP transaction type, thereby enabling action component SE 512 to apply financial values to each IP transaction. Business rules 520 may also identify potential dispute transactions before any billing is made, thereby simplifying later settlement and allowing faster resolution through the use of portals (e.g., portals 224, FIG. 2) that allow the potentially disputed IP transaction to be examined and evaluated in detail.

### Quality of Service

Further to settlement of monetary issues over multiple networks operated by more than one partner, systems 200 and 300 (IP transaction engine 318 in particular) allow quality of service measurements and statistics to be evaluated for IP transactions that involve more than one network. Since each IP transaction (e.g., IP transaction 102) includes event tokens and their associated measurements and statistics from across multiple networks, quality of service may be assessed for these transactions.

Settlement may also be based upon quality of service provided for each IP transaction. For example, value of service provided for each part of an IP transaction may be based upon a determined quality of service for that part of the IP transaction. Thus, where the provided service is problematic and of poor quality, the monetary value of the service is reduced. That is, if a network experiences problems resulting in poor service to the customer, the charge to the customer may be reduced accordingly and automatically.

As shown in FIG. 3, system 300 includes a diagnostic portal 330 that allows a network provider 324 to investigate the quality of service provided to one or more IP transactions 320 and thereby identify failing and/or failed components in one or more networks utilized by these IP transactions 320. Such diagnostic information, as provided by diagnostic portal 330, may identify networks problems that cannot be seen by examining IP transactions and associated measurements and statistics for IP transactions within a single network, or by examining any one or more devices of that network. That is, evaluating a complete IP transaction across multiple networks may highlight problems that cannot be identified by looking at data from each network individually.

### RFID Transaction Settlement

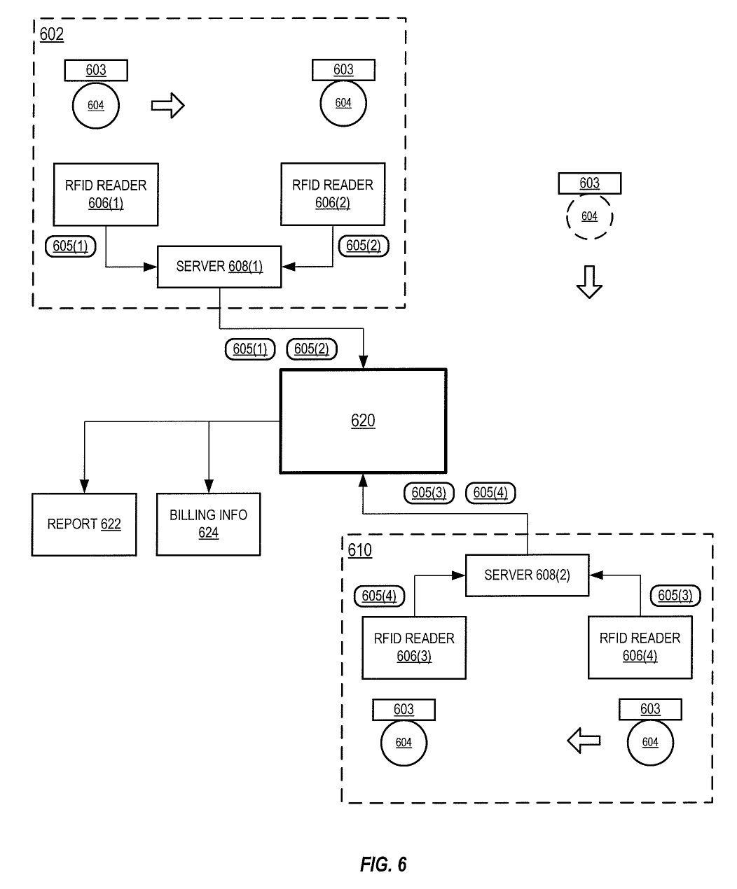

Other transactions may be modeled as a correlated collection of disparate events. For example, data received from RFID tags may be tracked with systems similar to those of FIGS. 2 and 3. FIG. 6 shows one exemplary system 620 for tracking RFID transactions for first and second processing plants 602 and 610. Processing plant 602 has two RFID readers 606(1) and 606(2) that connect to a server 608(1) for providing inventory and processing data of an object 603 within processing plant 602. Processing plant 610 has two RFID readers 606(3) and 606(4) that connect to a server 608(2) for providing inventory and processing information of object 603 within processing plant 610. In the example of FIG. 6, an RFID tag 604 is attached to object 603. Object 603 and RFID tag 604 are shown traveling through two processes within processing plant 602 and two processes within processing plant 610.

At a first location within processing plant 602, RFID reader 606(1) reads and identifies RFID tag 604 during application of the first process and sends RFID data 605(1) to server 508(1). RFID reader 606(2) reads and identifies RFID tag 604 during a second process and sends RFID data 605(2) to server 608(1). Object 603, with RFID tag 604, is then transported to processing plant 610 for further processing.

At a first location within processing plant 610, RFID reader 606(3) reads and identifies RFID tag 604 during a first process to object 603 and sends RFID data 605(3) to server 608(2). At a second location within processing plant 610, RFID reader 606(4) reads and identifies RFID tag 604 during application of a second process to object 603 and sends RFID data 605(4) to server 608(2).

Within processing plant 602, server 608(1) tracks processing of object 603 and within processing plant 610 server 608(2) tracks further processing of object 603. However, there is no cross correlation of processes applied to object 603 in processing plant 602 and in processing plant 610, particularly where processing plant 602 and processing plant 610 are operated by independent companies.

By sending RFID data 605 to an independent system 620 for tracking RFID data 605, and thus processing of object 603, reports 622 and billing information 624 may be generates for the entire processing cycle of object 603. System 602, since it receives information (RFID data 605) for each process applied to object 603, may also determine if these processes are applied incorrectly (e.g., out or order) and/or omitted for object 603 and may raise alerts accordingly. Where each process has a particular cost, system 620 may generate billing information applicable to object 603 for processes that were applied to object 603. That is, system 620 applies the incurred costs of object 603 within each processing plant 602, 610. This may be of particular importance where each processing plant has many processes of which only certain processes are to be applied to object 603.

### Healthcare—Tracking Transactions Generated as Patients are Processed

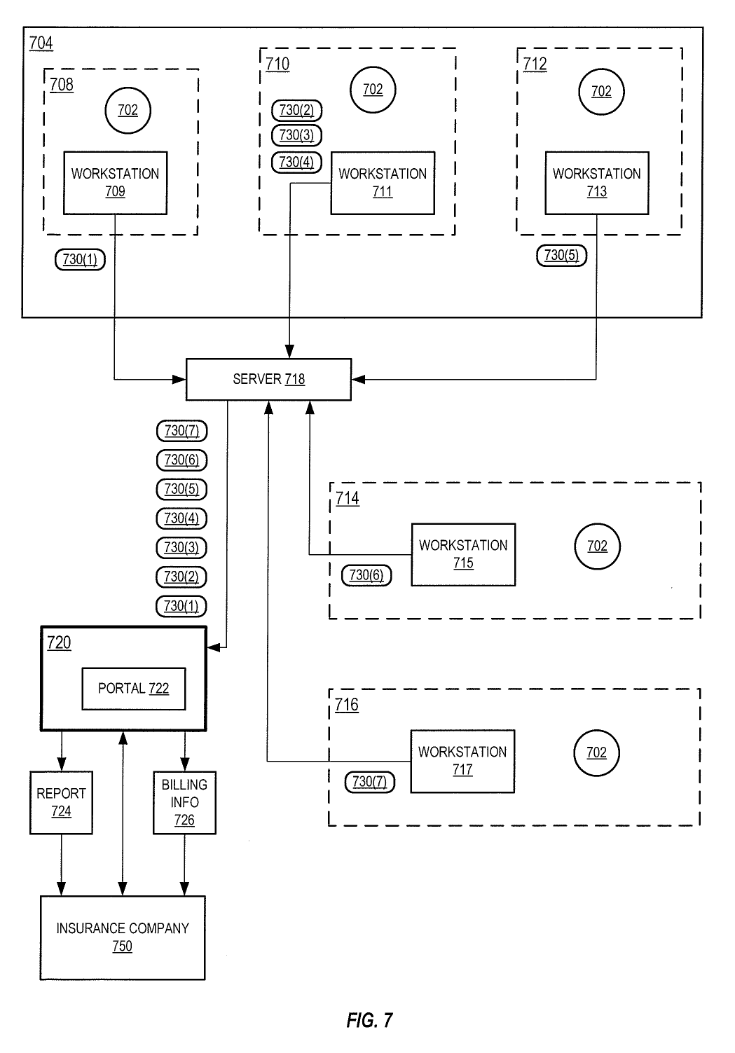

FIG. 7 shows a patient 702 receiving treatment within a hospital 704, filling a prescription at a pharmacy 714 and receiving follow up treatment at a clinic 716. Patient 702 is shown being admitted to hospital 704 at an administration area 708, where data of patient 702 is entered to a workstation 709 as data 730(1). Data 730(1) may then be sent to a server 718 for storage and further processing within hospital 704. Server 718 may be within hospital 704 or within a district office that supplied a data service to hospital 704, pharmacy 714 and clinic 716. Server 718 may represents one or more computer systems without departing from the scope hereof.

In the example of FIG. 7, patient 702 then receives treatment in a room 710, where a doctor enters details of diagnosis 730(2), treatments 730(3) and medication 730(4) using a workstation 711. Treatments 730(3) may represent several treatments given to patient 702 over several hours or even days. Workstation 711 is connected to server 718 and data 730(2), 730(3) and 730(4) is also sent to the server. Patient 702 may proceed to a radiology department 712 for an x-ray, whereupon details 730(5) of the x-ray are entered into a workstation 713 and sent to server 718. Upon release from hospital 704, patient 702 may visit pharmacy 714 to fill a prescription, whereupon details 730(6) of that prescription are entered into a workstation 715 and sent to server 718 for storage and further processing. Patient 702 may then make a follow-up visit to his general practitioner at clinic 716 whereupon details of the visit are entered to a workstation 717 and sent to server 718. Data items 730 represent events and actions of patient 702.

Although server 718 has traditionally provided billing services, this billing typically addresses each data item 730 individually, particularly where there has been a significant period between input of these data items. Further, server 718 makes no attempt to view the visits, treatments and medication given to patient 702 at hospital 704, pharmacy 714 and clinic 716 as a single transaction. Thus, there is no cross-checking of data 730 between events at hospital 704, pharmacy 714 and clinic 716.

By using a system 720 for tracking data items 730, a complete transaction of events and actions for patient 702 may be determined, verified against business rules, have monetary values applied and settled between hospital 704, pharmacy 714, clinic 716 and an insurance company 750.

System 720 may apply business rules (e.g., business rules 520, FIG. 5) to the received data items 730 to track the complete transaction with patient 702 and to identify any anomalies if the treatments and medication. In one example, system 720 may prevent a mistake where an important treatment has been missed for patient 702 or where a second treatment has not been performed within a required period of a first. Thus, though the use of business rules, system 720 may raise an alert when an anomaly is first noticed, potentially saving the life of patient 702. System 720 may generate reports 724 and billing information 726 based upon actually events, treatments, medication applied to patent 702, thereby alleviating mistakes and incorrect billing. This information may simplify processing of insurance claims within insurance company 750.

System 720 may also provide one or more portals 722 that allow access to stored data 730 within system 720. Portal 722 may allow authorized access to certain data 730 to resolve any disputes over settlement, for example. Since system 720 receives data 730 from multiple locations (e.g., hospital 704, pharmacy 714 and clinic 716), system 720 reduces time for financial settlement between each party and thus reduces any opportunity for error.

### Enterprise Network Security

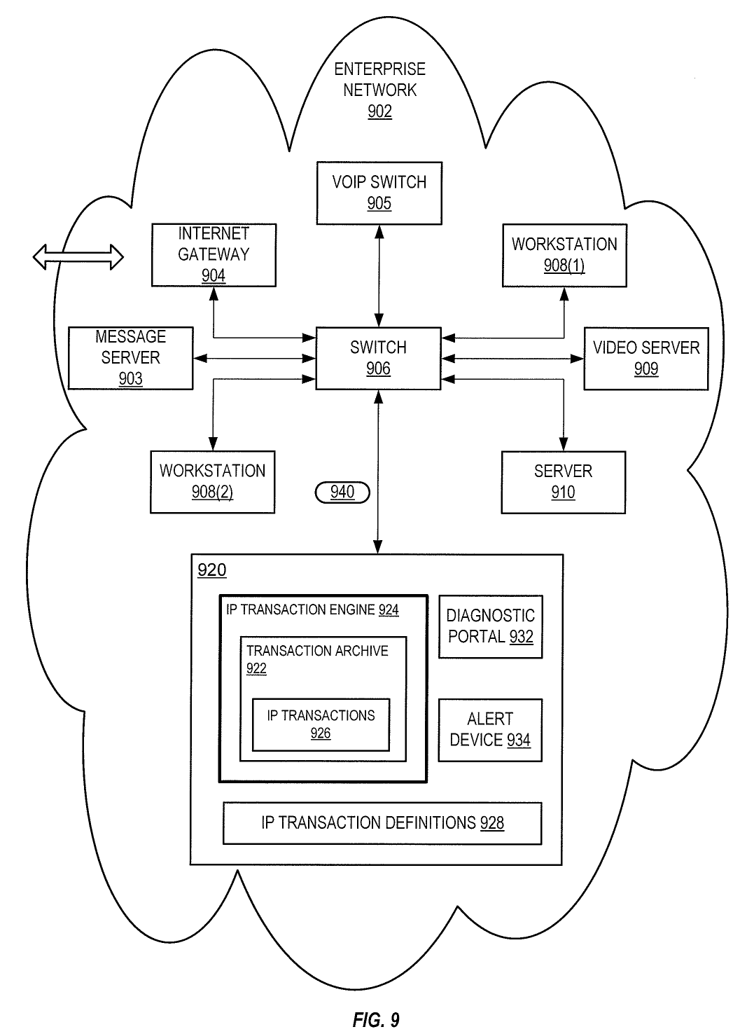

FIG. 9 shows one exemplary system 920 for tracking IP transactions within an enterprise network 902 to identify abnormal behavior. Network 902 has a message server 903, an internet gateway 904, a VoIP switch 905, a switch 906, two workstations 908(1) and 908(2), a video server 909 and a server 910. Network 902 may have more or fewer devices (e.g., gateway 904, switch 906, workstation 908 and server 910) without departing from the scope hereof. System 920 may be within network 902 or external to network 902 without departing from the scope hereof. System 920 connects to switch 906 and receives a plurality of event tokens 940 from switch 906 that are indicative of events occurring within network 902. For example, a user of workstation 908(1) interacts with internet gateway 904, via switch 906, to access the internet and interacts with server 910, via switch 906, to retrieve and send email messages. Each event that occurs within network 902 generates at least one event token 940 that is sent to system 920 where it is stored within a transaction archive 922 and processed by IP transaction engine 924 to form IP transactions 926.

IP transaction engine 924 includes IP transaction definitions 928 that define normal operation of network 902. In one embodiment, IP transaction engine 924 uses predictive logic to build a running baseline of expected transactions as part of the normal operation of network 902 and create IP transaction definitions 928. IP transaction engine 924 then transitions to an operation mode whereby it detects any abnormal IP transaction activity on enterprise network 902 by identifying significant behavioral patterns within the use of network 902.

In one example of operation, during a learn period, IP transaction engine 924 determines that, on average, a user of workstation 908(2) generated twenty emails and received sixty emails each day, and generated no more than four in any given one hour period. IP transaction engine 924 thus generates business rules within IP transaction definitions 928 to identify any behavior of the use of workstation 908(2) that differs from that. If the user of workstation 908(2) starts receiving significantly more than sixty emails per day, or starts sending significantly more than twenty emails per day, IP transaction engine 924 utilizes an alert device 934 to notify appropriate personnel that abnormal behavior is occurring at workstation 908(2) and identifying the user. The notified personnel may utilize a diagnostic portal 932 to further investigate the abnormal behavior before taking further action. Where the abnormal behavior is justified, as may occur when the user is given additional responsibility, IP transaction definitions 928 may be amended to allow such behavior.

In another example of operation, system 620 may perform a correlation of IP service use (e.g., use of internet gateway 904, VoIP switch 905, message server 903, video server 909, etc.) by users of workstations 908 and consumption analysis of how much each type of services is used by each user (i.e., an employee view of all IP services used). The determined information may be used by network people (e.g., IT managers, operators etc.) for capacity planning, security people for determining errant use of enterprise network 902, and HR people to provide evident of misconduct.

Thus, system 920 may be utilized to increase security of network 902 by tracking IP transaction within network 902 and to identify abnormal behavior within the network.

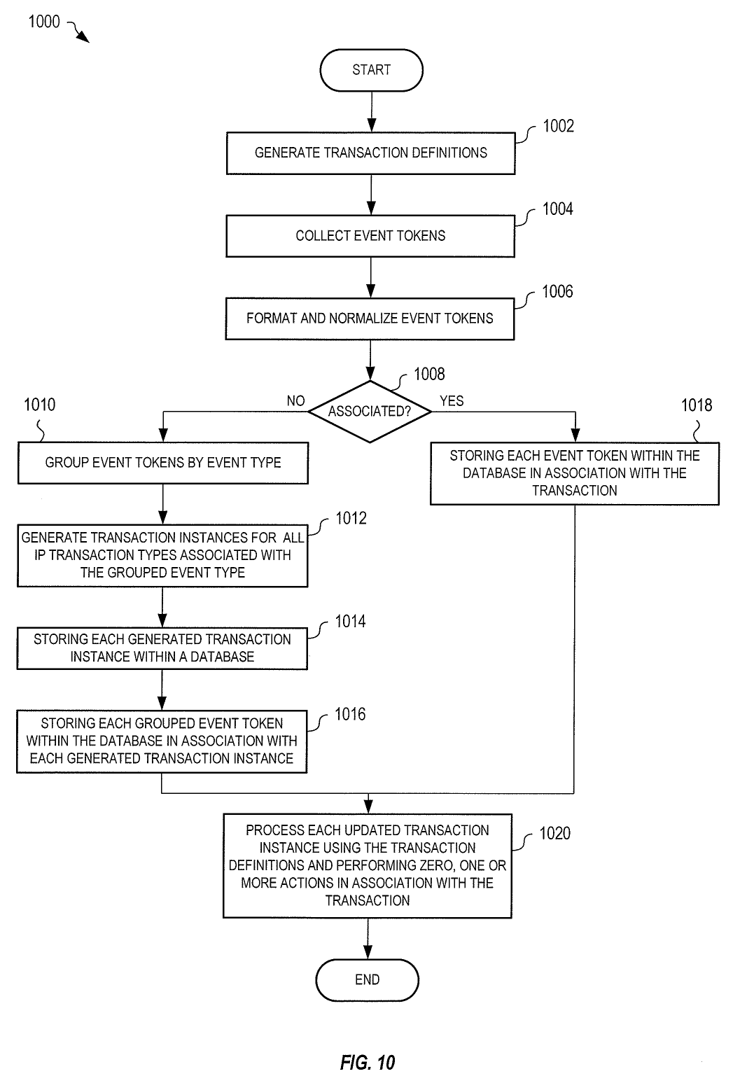

FIG. 10 is a flowchart illustrating one exemplary method 1000 for tracking state-based transactions. In step 1002, method 1000 generates transaction definitions. In one example of step 1002, IP transaction definitions are created to define the type, name and lifetime of each type of IP transaction to be processed, including a list of tokens, actions, and transactions that may be included for an instance of the IP transaction. The IP transaction definitions may also include token definitions and may refer to token types that are defined in other transaction definition documents.

In step 1004, method 1000 collects a plurality of event tokens. In one example of step 1004, collector/formatter 510 within IP transaction engine 318, FIG. 5, collects event tokens 150 from external source 504. In step 1006, method 1000 formats and normalizes event tokens collected in step 1004. In one example of step 1006, collector/formatter 510 formats and normalizes event tokens 150 into event tokens 508 as XML messages.

Step 1008 is a decision. If, in step 1008, method 1000 determines that event tokens collected in step 1004 are not associated with an existing instance of an IP transaction, method 1000 continues with step 1010; otherwise method 1000 continues with step 1018. In one example of step 1008, IP transaction broker 506 utilizes IP transaction data access 514 to determine if an existing instance of an IP transaction matches formatted and normalized event tokens 508. In step 1010, method 1000 groups formatted and normalized event tokens of step 1006 by event type. In one example of step 1010, IP transaction broker 506 groups formatted and normalized event tokens 508 by type. In step 1012, method 1000 generates IP transaction instances for each type of IP transaction in IP transaction definitions 519 that is associated with event token 508 event token type. In step 1014, method 1000 stores each of the generated IP transaction instances within a database. In one example of step 1014, IP transaction broker 506 utilizes IP transaction data access component 514 to store transactions 102(1)-102(N) to IP transaction archive 516. In step 1016, method 1000 stores each grouped event token within the database in association with each generated IP transaction instance. In one example of step 1016, IP transaction broker 506 utilizes IP transaction data access component 514 to store event tokens 508 within IP transaction archive 516 in association with IP transaction instances 102(1)-102(N). Method 1000 continues with step 1020.

In step 1018, method 1000 stores the event tokens in association with their associated IP transaction instances. In one example of step 1018, IP transaction broker 506 utilizes IP transaction data access component 514 to store formatted and normalized event tokens 508 within IP transaction archive 516 in association with one or more existing IP transaction instances 102.

In step 1020, method 1000 processes each of the updated IP transaction instances, and their associated event tokens, using the IP transaction definitions and performing zero, one or more actions in association with the IP transaction. In one example of step 1020, IP transaction broker 506 processes IP transactions 102 using IP transaction definitions 519 and generates request messages 507 that are assigned to one or more action components 512.

Changes may be made in the above methods and systems without departing from the scope hereof. It should thus be noted that the matter contained in the above description or shown in the accompanying drawings should be interpreted as illustrative and not in a limiting sense. Although IP transactions are used in certain of the examples herein, other types of state-based transaction may be tracked. The following claims are intended to cover all generic and specific features described herein, as well as all statements of the scope of the present method and system, which, as a matter of language, might be said to fall there between.

What is claimed is:

1. A method for tracking a state-based transaction, comprising:
generating transaction definitions that define each type of state-based transaction and its associated business rules;
collecting a plurality of event tokens from devices of one or more networks;
formatting and normalizing the event tokens;
for event tokens not associated with a stored IP transaction:
grouping the event tokens into groups of like event token type;
generating an IP transaction instance for each type of IP transaction in the IP transaction definitions that is associated with the event token type;
storing each of the generated IP transaction instances within a transaction archive;
storing, for each of the generated IP transaction instances, each of the grouped event tokens in association with the stored IP transaction;
for event tokens that are associated with a stored IP transaction instance:
storing each of the event tokens in association with their associated IP transaction instances;
processing each of the IP transaction instances, and the associated event tokens, using the IP transaction definitions and performing zero, one or more actions in association with the IP transaction instance.

2. The method of claim 1, further comprising determining a financial value for the IP transaction once completed.

3. The method of claim 2, further comprising determining completion of the IP transaction based upon the IP transaction state.

4. The method of claim 1, the step of formatting and normalizing further comprising converting the event tokens into XML messages.

5. A system for tracking state-based transactions from disparate sources, comprising:
a collector/formatter for collecting and formatting event tokens from the sources;
a transaction broker for grouping the formatted event tokens into groups of like event token types and for creating one state-based transaction containing each of the event tokens for each possible transaction type associated with the event token type of each group, if the event tokens are not associated with at least one existing event-based transaction;
a transaction data access component for storing each of the state-based transactions and associated event tokens into a transaction archive; and
a plurality of action components for taking actions, based upon one or more transaction definitions, in association with one or more of the state-based transactions;
wherein at least one of the actions determines a transaction state for one or more of the state-based transactions, the transition state indicating whether the state-based transaction is complete.

6. A method of storing state-based transaction information, comprising:
receiving event tokens for one or more state-based transactions;
if the event tokens are not associated with an existing transaction:
grouping the event tokens based upon an event token type;
generating a state-based transaction for each transaction type within a transaction definition document and in association with each of the event tokens of the group;
storing the state-based transactions and their associated event tokens in a transaction archive;
if the event tokens are associated with an existing state-based transaction:
storing the event token within the transaction archive in association with the existing state-based transaction.

7. A method for determining missing events, comprising:
defining transaction definitions for one or more state-based transactions, the transaction definitions specifying one or more states and state transitions for each of the one or more state-based transactions;
receiving one or more event tokens;
if the event tokens are not associated with a state-based transaction within a transaction archive:
grouping the event tokens according to event token type;
generating a state-based transaction for each transaction type of state-based transactions defined within the transaction definitions and associating with each of the generated state-based transactions each of the event tokens of the group;
storing the state-based transactions and their associated event tokens in a transaction archive;
if the event tokens are associated with an existing state-based transaction:
storing the event token within the transaction archive in association with the existing state-based transaction; and
determining, for each incomplete state based transaction within the transaction archive, which events are missing based upon the transaction definitions.

8. A method of diagnosing problems across multiple networks, comprising:
tracking state-based transactions by receiving, processing and storing event tokens from the multiple networks;
determining quality of service for each of the state-based transactions;
identifying state-based transactions with problems based upon the determined quality of service; and
evaluating event tokens of the state-based transaction to identify one or more devices within the multiple networks.

9. A system for settling transactions between peering networks, comprising:
means for tracking state-based transactions across the peering networks;
means for monetizing the state-based transactions; and
means for generating billing information based upon the monetized state-based transactions.

10. A method for identifying abnormal behavior within an enterprise network, comprising:
collecting event tokens of state-based transactions within the network for a defined period during which normal activity occurs on the network;
determining normal behavior of the network based upon the collected event tokens;
generating transaction definitions for the determined normal behavior and including business rules that identify abnormal behavior on the network;
collecting event tokens of state-based transactions within the network after the defined period;
evaluating the event tokens to identify state-based transactions of abnormal behavior;
if abnormal behavior is identified, generating at least one alert for the abnormal behavior.
